(19) United States
(12) Patent Application Publication
(10) Pub. No.: US 2005/0192909 A1
(43) Pub. Date: Sep. 1, 2005

(54) Conflict resolution apparatus

(76) Inventor: Mark A. Williams, Grand Blanc, MI (US)

Correspondence Address: GIFFORD, KRASS, GROH, SPRINKLE & CITKOWSKI, P.C, PO BOX 7021, TROY, MI, 48007-7021, US

(21) Appl. No.: 10/894,094

(22) Filed: Jul. 19, 2004

Related U.S. Application Data
(60) Provisional application No. 60/548,229, filed on Feb. 27, 2004.

(51) Int. Cl. G06F 17/60

(52) U.S. Cl. 705/80

(57) ABSTRACT

The present invention provides an apparatus and method for use in resolving a conflict amongst a plurality of individuals wherein the apparatus provides a hands-on approach to conflict resolution as well as having utility in promoting open discussion toward resolving the conflict. The apparatus includes a plurality of objects wherein the objects are used to identify individuals involved in the conflict and to identify factors, actions and behaviors that are recognized as being significant with regard to causing the conflict as well as being significant for resolving the conflict. To accomplish the hands-on approach to conflict resolution, the plurality of objects are first used by the facilitator, and the individuals, for identifying and promoting discussion of the predetermined factors involved in creating the conflict. Thereafter, the plurality of objects are used by the facilitator and the individuals for identifying and promoting discussion of predetermined solutions to the conflict.

### RELATED APPLICATIONS

The present application claims the benefit U.S. Provisional Application No. 60/548,229 that has a filing date of Feb. 27, 2004.

### FIELD OF THE INVENTION

The present invention relates to techniques and methods for conflict resolution and more particularly to an apparatus that encourages individual participation in resolving a conflict by using a hands-on approach in addition to open discussion.

### BACKGROUND OF THE INVENTION

It is appreciated that the conflicts that frequently occur in social, professional, domestic or political environments are an inevitable part of life, and that learning how to respond or deal with these conflicts constructively is essential. Many of today's techniques for conflict resolution involve negotiation, mediation, and/or consensus decision-making wherein each technique primarily requires the individuals involved in the conflict to participate in open discussions.

These discussions are needed to identify, evaluate and facilitate implementation of actions/behaviors that may be used to prevent a similar conflict from occurring in the future, and/or remedy the harms caused to individuals involved in the conflict. In some cases, mediation manuals, videotapes and other audio/visual aids are provided to assist individuals in learning and practicing basic communication skills and techniques that are necessary for reaching mutually agreeable solutions to disputes and providing other lifelong benefits.

Although many of these devices are useful in teaching conflict resolution methods and techniques, they are not adapted to encourage individual participation in conflict resolution beyond an open discussion session. It is appreciated that open discussions may not always produce desired results, especially when a conflict involves individuals that have difficulty expressing themselves verbally, have introverted personalities, or are simply unwilling to participate in open discussions.

Accordingly, there is a need for an apparatus that encourages hands-on participation as well as open discussion toward identifying the factors, actions and behaviors that create specific conflicts as well as those factors, actions and behaviors that are essential to resolving the conflict.

### SUMMARY OF THE INVENTION

The present invention provides an apparatus and method for use in resolving a conflict amongst a plurality of individuals wherein the apparatus provides a tangible or hands-on approach to conflict resolution as well as having utility in promoting open discussion toward resolving the conflict.

The apparatus includes a plurality of objects wherein at least one object is adapted to be disposed with markings indicative of a facilitator for resolving the conflict.

A first portion of the plurality of objects is adapted to be disposed with markings indicative of at least one of the plurality of individuals involved in the conflict.

A second portion of the plurality of objects includes opposing sides wherein a first side is disposed with predetermined markings indicative of at least one factor involved in creating the conflict and the other side is disposed with predetermined markings indicative of at least one solution to obviate or remedy harm caused by the at least one factor.

To provide the hands-on approach to conflict resolution, the at least one object, the first portion of objects, and the first side of the second portion of objects are used by the facilitator and the plurality of individuals for identifying and promoting discussion of the predetermined factors involved in creating the conflict. Thereafter, the other side of the second portion of objects are used by the facilitator and the plurality of individuals for identifying and promoting discussion of predetermined solutions to the conflict.

Accordingly, the present invention provides a tool for use in conflict resolution that encourages hands-on participation as well as open discussion toward identifying the factors, actions and behaviors that create specific conflicts. Additionally, the invention provides a tangible means for identifying factors, actions and behaviors that can be employed to prevent and/or remedy harms caused to individuals involved in the conflict. Thus, the present invention not only enhances the effectiveness of conventional methods of conflict resolution but also allows for participants in the conflict to be more instrumental in reaching a resolution through hands-on involvement.

### BRIEF DESCRIPTION OF THE DRAWINGS

A better understanding of the present invention will be had upon reference to the attached drawings wherein like reference numerals refer to like parts throughout and wherein:

FIG. 1 illustrates an exemplary embodiment of the conflict resolution apparatus as according to the invention;

FIG. 2 illustrates a reverse side of the exemplary embodiment of the conflict resolution apparatus of FIG. 1 as according to the invention;

FIG. 3 illustrates an optional configuration of the conflict resolution apparatus of FIG. 1 as according to the invention;

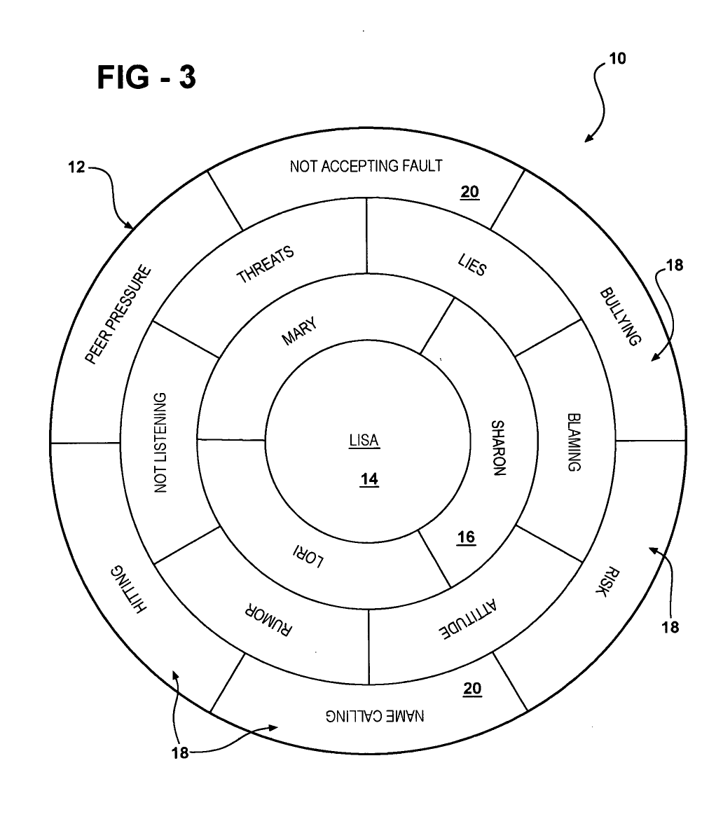

FIG. 4 exemplifies a preferred embodiment of the conflict resolution apparatus that includes a placemat for disposing the plurality of objects thereon during the conflict resolution process as according to the invention;

FIG. 5 illustrates an embodiment of the plurality of objects wherein the objects include symbolism as well as textual information; and

FIG. 6 illustrates the method of conflict resolution being facilitated through the use of computer technology.

### DESCRIPTION OF THE INVENTION

The present invention provides an apparatus derived from combining conflict resolution experiences and creative design. The apparatus is used with known conflict resolution techniques for facilitating the attainment of a mutually acceptable agreement between individuals who refuse to admit their involvement in a conflict, lack the ability to see just how their involvement played a part in creating the conflict, and/or how their involvement is a necessary part of the resolution.

The present invention has utility in assisting individuals in conflict resolution in many environments involving minors or adults in social settings, classroom settings, labor and employment relations, racial relations, gender relations, domestic relations or other settings and environments where conflicts amongst individuals are known to occur.

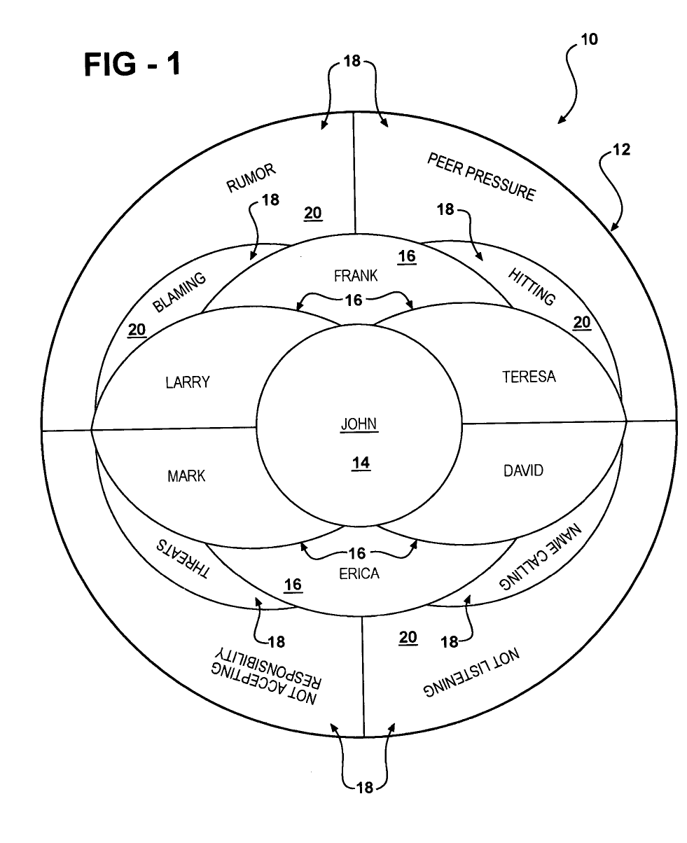

With reference to FIG. 1, an exemplary embodiment of the conflict resolution apparatus 10 is illustrated. The apparatus 10 includes a plurality of objects 12 including at least one object 14 adapted to be disposed with markings indicative of an individual who will act as the facilitator of the conflict resolution session. It is appreciated that the named facilitator may be an individual who is a party in the conflict to be resolved. In this manner, the present invention does not require the facilitator to be a professional or individual trained in conflict resolution techniques because the apparatus as provided includes all the instructive materials and tools necessary for a layperson, as well as a professional, to facilitate the process of conflict resolution.

The plurality of objects may be provided as pieces to a puzzle adapted to be joined together to form a single object. The plurality of objects may be formed of various types of sheet material suitable for such purpose such as cardboard, foam rubber, laminated materials, wood, plastic or other materials known to those skilled in the art.

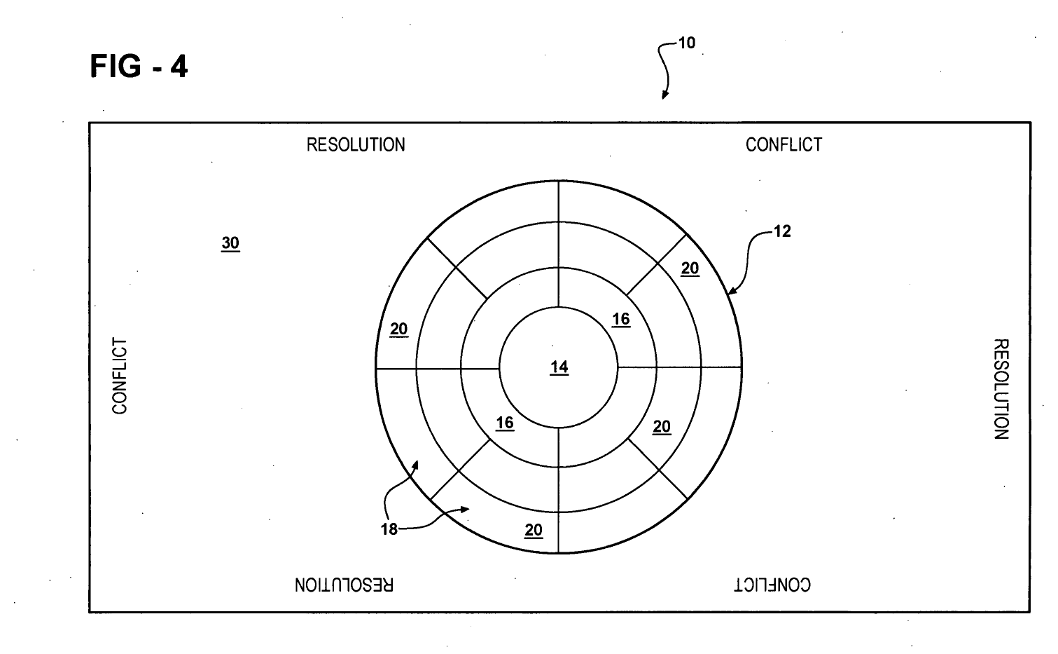

With reference to FIG. 4, a placemat 30 may be provided for disposing the plurality of objects 12 thereon during the conflict resolution process. The placemat 30 and/or the plurality of objects 12 may be magnetized such that the objects 12 can be removably adhered to the placemat as desired. In this manner, the placemat 30 may be disposed on a vertical support surface such as a wall, chalkboard, easel or other vertical surface whereby a plurality of individuals involved in the conflict may view the apparatus easily and conveniently. It is appreciated, however, that other means of adhering the plurality of objects 12 to the placemat 30 may be employed which illustratively include adhesives or adhesive materials, Velcro®, electrostatic materials, pushpins or other conventional fastening means suitable for such purpose without exceeding the scope of the invention.

Referring again to FIG. 1, a first portion 16 of the plurality of objects 12 is provided wherein each piece is adapted to be disposed with markings indicative of at least one of the plurality of individuals involved in the conflict. As illustrated, these markings appear as the given names of the individuals involved in the conflict. However, it is appreciated that nicknames, professional titles, group or organizational names, geographic identifiers, demographic identifiers, political designations or other identifiers may be used to indicate the parties involved in the conflict.

A second portion 18 of the plurality of objects 12 is provided wherein each piece of the second portion 18 includes a first side 20 disposed with predetermined markings indicative of at least one factor involved in creating the conflict to be resolved. Preferably, the second portion 18 of objects 12 are disposed with markings indicative of factors commonly known to promote or create a particular type of conflict amongst a subject group wherein the factors have been obtained from historical data and/or experience from individuals that practice mediation and conflict resolution processes.

Illustratively, if the conflict to be resolved is one involving juveniles, the first side 20 of the second portion of objects 18 may be marked with factors such as, “rumors, peer pressure, name calling and hitting”. If the apparatus were designed for conflict resolution in domestic relations, the first side 20 of the second portion of objects 18 may be disposed with markings indicative of factors such as, “lack of communication, not listening, finances, not sharing responsibility for children, and decision making”. Accordingly, the apparatus 10 as described may be adapted for addressing factors involved in a plurality of distinct conflicts in which individuals become involved.

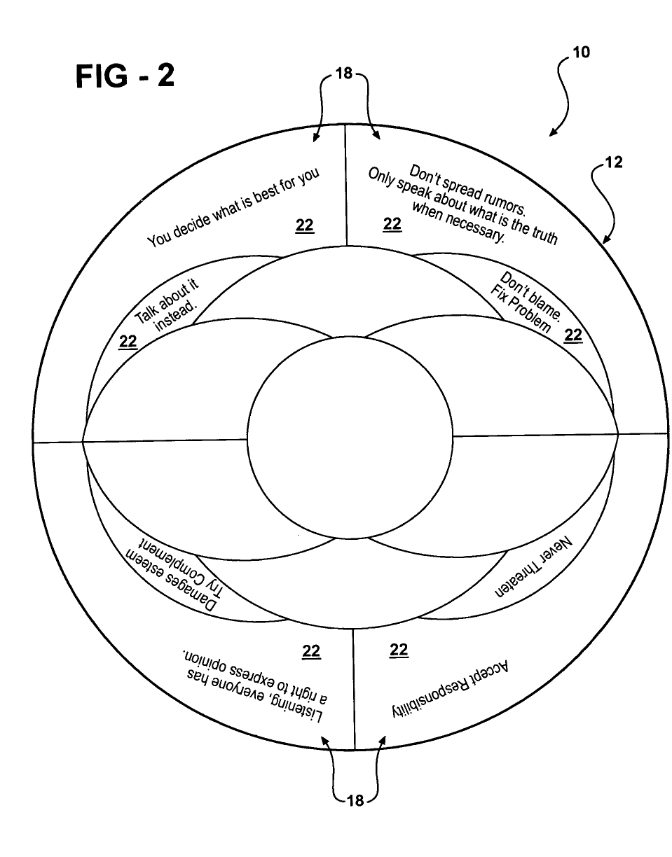

With reference to FIG. 2, a reverse side of the apparatus 10 illustrated in FIG. 1 is shown. As illustrated, the other side 22 of the second portion of objects 18 is disposed with predetermined markings indicative of at least one solution to obviate or remedy harm caused by the at least one factor disposed on the first side 20 of the second portion of objects 18. As with the factors that are commonly known to contribute to a specific conflict to be resolved, the solutions or action/behaviors disposed on the other side 22 of the second portion of objects 18 is derived from historical data, research and/or experience relative to the particular conflict. Preferably, the factors and solutions disposed on the opposing sides of the second portion of objects 18 are preprinted on each object piece.

Alternatively, the opposing sides 20 and 22 of the second portion of pieces 18 may be disposed with the appropriate factors and solutions involved in the particular conflict prior to starting or during the conflict resolution process. In this manner, the apparatus 10 is made readily adaptable for use in resolving a variety of conflicts in a single package or can be adapted to address a specific type of conflict resolution. However, the preferred embodiment includes object pieces 18 preprinted with factors and solutions that relate to a particular conflict to be resolved.

In using the apparatus 10, the at least one object 14 to be disposed with the facilitator's name is disposed on the placemat 30 first wherein those involved in the conflict resolution process are made aware that this individual is responsible for controlling the flow of the conflict resolution process. Thereafter, the first portion of objects 16 that include the names of the individuals involved in the conflict are placed adjacent the object piece 14 preferably by each individual involved in the conflict. Accordingly, at this point the individuals involved recognize and accept the fact that they have either played a role in creating the conflict or are required to play a role in resolving it.

Next, each individual involved begins to select from the second portion of objects 18 disposed with factors that they believe contributed to the creation of the conflict until as many or all factors involved have been identified and disposed on the placemat 30. At this point each individual is experiencing hands-on involvement in resolving their particular conflict. This experience is coupled with open discussion of the factors and solutions surrounding the conflict such that an overall comprehensive method of conflict resolution is provided as according to the present invention.

It is appreciated that the final step in the conflict resolution process using the apparatus 10 involves the viewing and discussion of the solutions disposed on the other side 22 of the second portion of pieces 18 which may be accomplished by simply turning the plurality of objects 12 over to the reverse side such that the other side 22 of the second portion of pieces 18 is presented on the placemat 30.

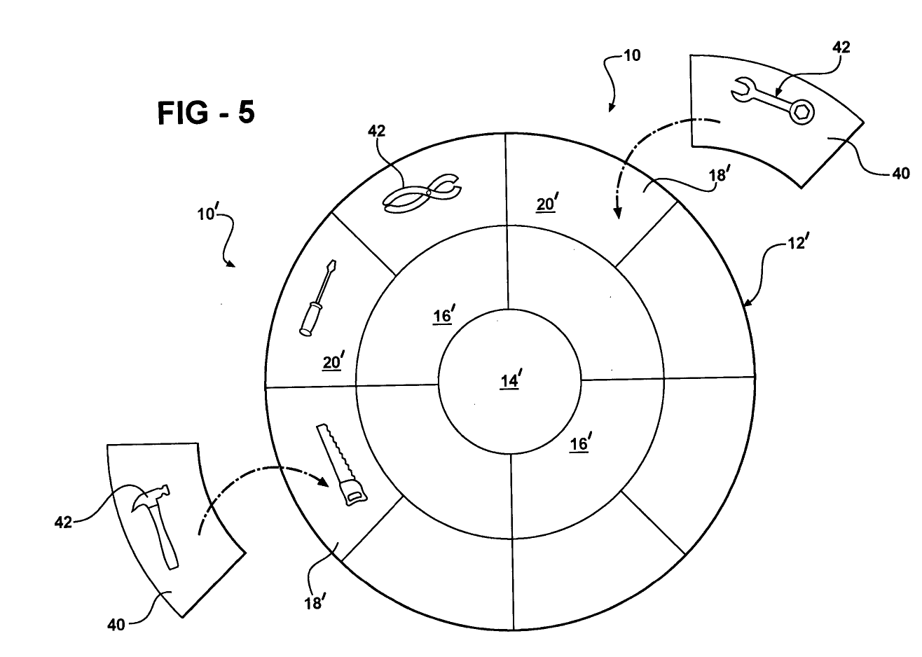

Alternatively, as best illustrated in FIG. 5 a third portion 40 of the plurality of objects 12 may be disposed with predetermined markings indicative of at least one solution to obviate or remedy harm caused by the at least one factor disposed on the first side 20 of the second portion of objects 18′. The third portion 40 of pieces of the plurality of objects 12′ are preferably formed of substantially the same shape and size of second portion of pieces 18′. In this manner, the third portion of pieces are operative to be disposed on top of the first side 20′ of the second portion of pieces 18′ whereby discussion of the solutions is facilitated without having to turn the second portion of pieces 18′ to the reverse side.

Although the exemplary embodiment in FIG. 1 of the apparatus 10 for use in conflict resolution is provided in the form of a board game or puzzle, it is appreciated that the plurality of objects 12 may be provided in other forms without exceeding the scope of the invention illustratively including three-dimensional objects provided in various shapes and sizes which may be formed of various materials. Referring again to FIG. 5, the plurality of objects may be disposed with symbolic illustrations/graphics 42 in conjunction with the other markings to further stimulate participation in the conflict resolution process beyond open discussion with visual aids. These symbolic illustrations/graphics may illustratively be provided as images of tools, animated characters, images of nature, images of animals or the like.

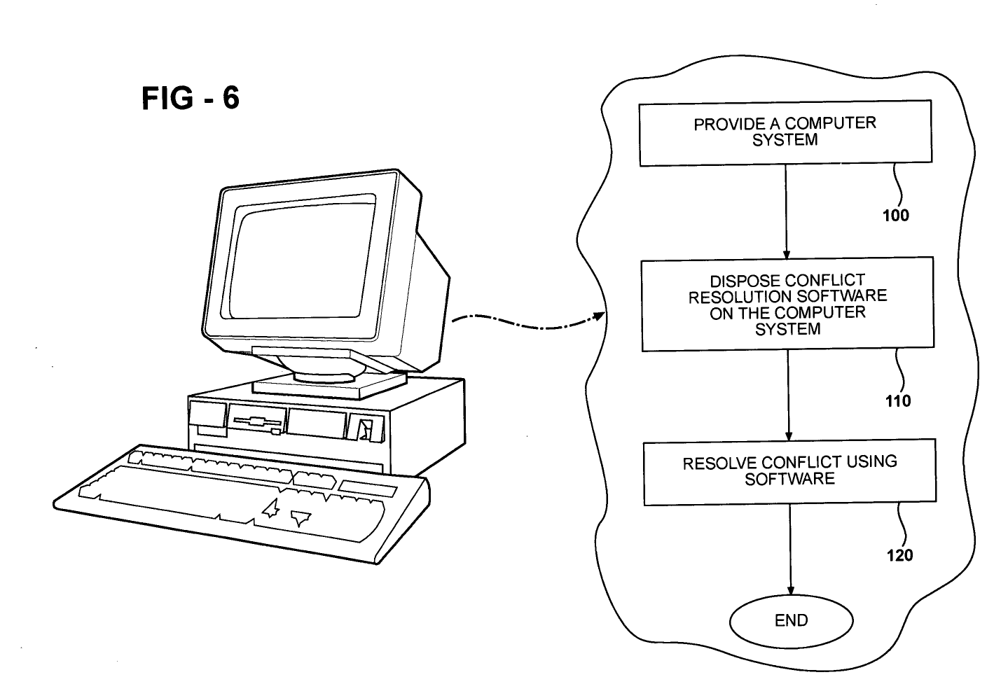

Alternatively, the method and apparatus 10 may be provided in the form of computer software that can be downloaded to a computer system for facilitating an interactive approach toward conflict resolution taking advantage of the benefits of modern technology. As illustrated in FIG. 6, at 100, a computer system is provided that is preferably comprised of a plurality of computers networked together either locally or remotely via the Internet. At 110, the conflict resolution software may either be disposed on each computer within the computer system or run from a service provider website. The conflict resolution software provides a virtual environment having all the elements of the apparatus 10 in computer imagery. At 120, the individuals use the computer software to resolve the conflict following the same steps as when using the board version. In this manner, a group of individuals can participate in conflict resolution from locations remote from the facilitator and each other simply by employing the power of the computer and the Internet technologies.

Having described the invention, various alternative embodiments may become known to those having skill in the art that do not depart from the spirit or scope of the present invention as according to the appended claims.

1. An apparatus for use in resolving a conflict amongst a plurality of individuals, said apparatus comprising:
a plurality of objects including at least one object adapted to be disposed with markings indicative of a facilitator;
a first portion of said plurality of objects wherein each piece is adapted to be disposed with markings indicative of at least one of the plurality of individuals involved in the conflict;
a second portion of said plurality of objects having opposing sides wherein a first side is disposed with predetermined markings indicative of at least one factor involved in creating the conflict and the other side is disposed with predetermined markings indicative of at least one solution to obviate or remedy harm caused by said at least one factor; and
wherein said at least one object, said first portion of objects, and said first side of said second portion of objects are used by the facilitator and the plurality of individuals for identifying and promoting discussion of said predetermined factors involved in creating the conflict and the other side of said second portion of objects are used by the facilitator and the plurality of individuals for identifying and promoting discussion of predetermined solutions to the conflict.

2. The apparatus of claim 1 wherein said objects are pieces to a puzzle adapted to be joined together to form a single object.

3. The apparatus of claim 1 wherein the facilitator is one of the plurality of individuals involved in the conflict.

4. The apparatus of claim 1 further comprising a placemat for disposing said plurality of objects thereon.

5. The apparatus of claim 4 wherein said placemat and said plurality of objects are magnetized.

6. The apparatus of claim 1 being provided as computer software adapted to be disposed on a computer system for facilitating conflict resolution.

7. The apparatus of claim 1 being adapted for resolving conflicts involving juveniles.

8. The apparatus of claim 1 being adapted for resolving conflicts involving domestic relations.

9. The apparatus of claim 1 being adapted for resolving a conflict involving individuals selected from a group of individuals involved in labor relations, employer/employee relations, racial relations, and gender relations.

10. An apparatus for use in resolving a conflict amongst a plurality of individuals, said apparatus comprising:
a plurality of objects including at least one object adapted to be disposed with markings indicative of a facilitator;
a first portion of said plurality of objects wherein each piece is adapted to be disposed with markings indicative of at least one of the plurality of individuals involved in the conflict;
a second portion of said plurality of objects disposed with predetermined markings indicative of at least one factor involved in creating the conflict; and
a third portion of said plurality of objects disposed with predetermined markings indicative of at least one solution to obviate or remedy harm caused by said at least one factor wherein said at least one object, said first, said second, and said third portion of objects are used by the facilitator and the plurality of individuals for identifying and promoting discussion of said predetermined factors involved in creating the conflict and for identifying and promoting discussion of predetermined solutions to the conflict.

11. The apparatus of claim 10 wherein the third portion of said plurality of objects have substantially equivalent dimensions as said second portion of said plurality of objects and are adapted to be disposed on top thereof for facilitating discussion of said predetermined solutions to said factors.

12. A method for use in resolving a conflict amongst a plurality of individuals, said method comprising the steps of:
providing a plurality of objects, including at least one object adapted to be disposed with markings indicative of a facilitator;
disposing a first portion of the plurality of objects with markings indicative of the plurality of individuals involved in the conflict;
disposing a first side of a second portion of the plurality of objects with predetermined markings indicative of at least one factor involved in creating the conflict;
disposing a second side of the second portion of objects with predetermined markings indicative of at least one solution to obviate or remedy harm caused by the at least one factor;
using the first side of the second portion of objects for identifying and promoting discussion amongst the plurality of individuals of the predetermined factors involved in creating the conflict; and
using the second side of the second portion of objects for identifying and promoting discussion amongst the plurality of individuals of predetermined solutions to the conflict.

13. The method of claim 12 further comprising the step of disposing at least one object with markings indicative of a facilitator for resolving the conflict amongst the plurality of individuals.

14. The method of claim 12 further comprising the step of providing a placemat for arranging the plurality of objects on during the conflict resolution process.
